(19) United States
(12) Patent Application Publication
(10) Pub. No.: US 2023/0224634 A1
(43) Pub. Date: Jul. 13, 2023

(54) RECORDING DEVICE AND RECORDING METHOD THEREOF

(71) Applicant: GuangZhou LAVA MUSIC LLC., Guangzhou (CN)

(72) Inventors: ZI-TIAN LU, Guangzhou (CN); Cheuk Ho TSE, Guangzhou (CN); SHUAI YIN, Guangzhou (CN)

(21) Appl. No.: 18/087,163

(22) Filed: Dec. 22, 2022

(30) Foreign Application Priority Data
Dec. 23, 2021 (CN) 202111593188.1
Dec. 23, 2021 (CN) 202123269899.1

(51) Int. Cl. H04R 3/00; G10K 11/178

(52) U.S. Cl. CPC H04R 3/005; G10K 11/17823

(57) ABSTRACT

The present disclosure includes a recording device including a pickup unit, a microphone, and a pickup assembly. The pickup assembly includes a filter circuit unit, a codec, and an audio processing circuit unit. The pickup assembly is used to mix sounds of the musical instrument picked up by the pickup unit and human voices picked up by the microphone. The present disclosure also provides a musical instrument recording method, including the following: picking up the sounds of the musical instrument; picking up the human voices; and processing the sound recorded, in order to solve the problem of cumbersome connection and poor results during recording and live broadcasting of musical instruments.

### FIELD

The subject matter relates to recording technology, and in particular, to recording device and recording method thereof.

### BACKGROUND

When users create short videos or perform live with musical instruments, they may use various devices to connect musical instruments to audio, cell phones (or computers) and other devices in order to record and broadcast the audio data of the musical instruments and human voices. In the conventional technology, when users use sound cards and other devices as the medium between musical instruments and peripherals and terminals for recording and live streaming, the connection process is cumbersome and prone to poor results, and the existing recording devices cannot meet the recording and live streaming needs of users. Thus, the conventional technology may need improvement.

### BRIEF DESCRIPTION OF THE DRAWINGS

FIG. 1 is a schematic view of a recording device in a first embodiment according to the present disclosure.

FIG. 2 is a schematic view of a pickup assembly in FIG. 1 according to the present disclosure.

FIG. 3 is a schematic view of a second embodiment of the recording device according to the present disclosure.

FIG. 4 is a schematic view of a third embodiment of the recording device according to the present disclosure.

FIG. 5 is a schematic view of a fourth embodiment of the recording device according to the present disclosure.

FIG. 6 is a schematic view of a fifth embodiment of the recording device according to the present disclosure.

FIG. 7 is a flow chart of the recording method according to the present disclosure.

### DETAILED DESCRIPTION

The following descriptions refer to the attached drawings for a more comprehensive description of this application. Sample embodiments of this application are shown in the attached drawings. However, this application can be implemented in many different forms and should not be construed as limited to exemplary embodiments set forth herein. These exemplary embodiments are provided to make this application thorough and complete, and to adequately communicate the scope of this application to those skilled in the field. Similar diagram labels represent the same or similar components.

The terms used herein are intended only to describe the purpose of particular exemplary embodiments and are not intended to limit this application. As used herein, the singular forms “one”, “one” and “the” are intended to include the plural as well, unless the context otherwise clearly indicates it. In addition, when used herein, the words “include” and/or “include” and/or “have”, integers, steps, operations and/or components, do not exclude additional or pluralities of features, regions, integers, steps, operations, components, and/or groups thereof.

Unless otherwise defined, all terms used herein (including technical and scientific terms) have the same meaning as would normally be understood by ordinary technicians in the field of this application. In addition, unless expressly defined in the context, terms such as those defined in a general dictionary shall be construed to have meanings consistent with those in the relevant technology and in the content of this application, and shall not be construed to have idealistic or overly formal meanings.

Examples of embodiments are described below in combination with the attached drawings. It should be noted that the components depicted in the attached drawings may be shown not to scale; the same or similar components will be assigned the same or similar drawing mark representation or similar technical terms.

The following is a detailed description of the specific implementation of this application, referring to the attached drawings.

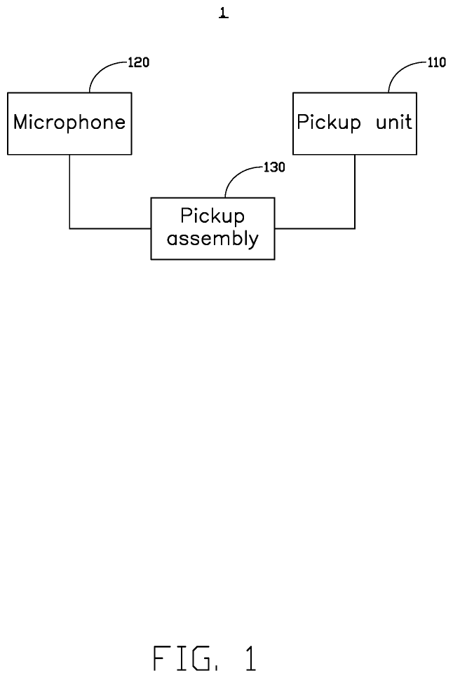

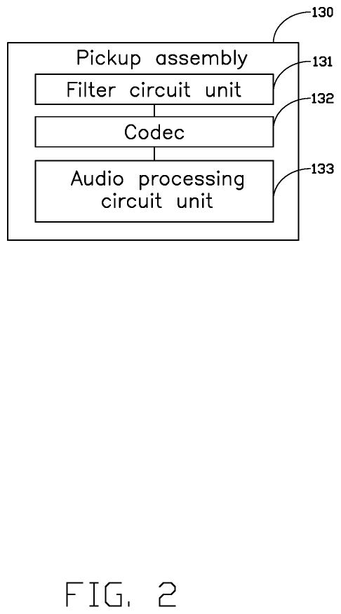

As shown in FIG. 1 to FIG. 2, a recording device 1 includes a pickup unit 110, a microphone 120, and a pickup assembly 130. The pickup unit 110 is used to pick up the sound of a musical instrument. The microphone 120 is used to pick up the human voice. The pickup assembly 130 includes a filter circuit unit 131, a codec 132, and an audio processing circuit unit 133. The pickup unit 110 is connected to the filter circuit unit 131. The filter circuit unit 131 is connected to the codec 132. The codec 132 is connected to audio processing circuit unit 133. The microphone 120 is connected to audio processing circuit unit 133. The pickup assembly 130 is used to mix the sound of the musical instrument picked up by the pickup unit 110 and the human voice picked up by the microphone 120.

The microphone 120 can pick up human voices, such as singing voices. The pickup unit 110 can pick up instrument sounds, such as guitar playing sounds. The pickup assembly 130 mixes and records the human voice as well as the instrument sound to achieve the guitar singing performance recording. The pickup assembly 130 allows for easy and fast recording as well as mixing. The recording device 1 is simple to operate, and the recording effect as well as the mixing effect is good, which can improve the user's experience in using the instrument for playing and singing recording as well as the live broadcast process.

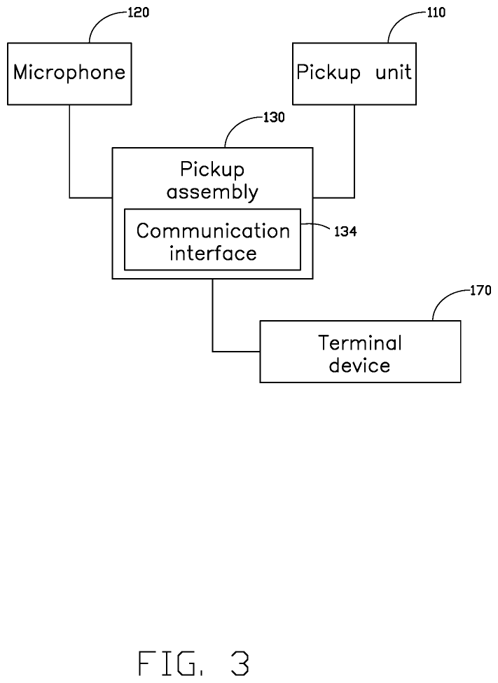

In a second embodiment as shown in FIG. 3, the pickup assembly 130 further includes a communication interface 134. The communication interface 134 is connected to the audio processing circuit unit 133, and the communication interface 134 is used to communicate with the terminal device 170. And the pickup assembly 130 in the second embodiment also includes the filter circuit unit 131, the codec 132 and the audio processing circuit unit 133 as shown in FIG. 2.

The communication interface 134 may be a USB interface or a Bluetooth interface. During live streaming or recording, the communication interface 134 connects the terminal device 170 to the pickup assembly 130, which may include cell phone, computer, headphone, microphone, audio, etc. On the one hand, the pickup assembly 130 transmits the recorded and processed human voice and instrument sound to the terminal device 170 through the communication interface 134, allowing the user to synchronize the instrument sound as well as the human voice when using the terminal device 170 for live streaming. On the other hand, the processed human voice as well as the instrument sound can also be stored or played on the terminal device 170 to facilitate video and audio editing by the creator.

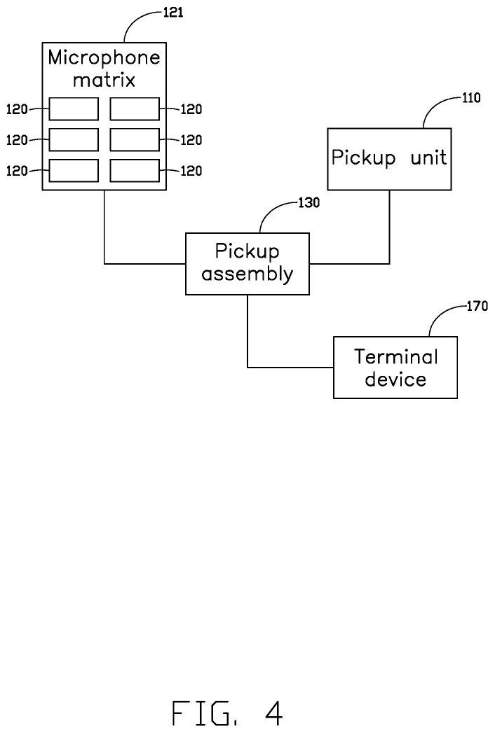

In a third embodiment, as shown in FIG. 4, the recording device 1 includes a microphone matrix 121 that is used to pick up human voices and assist in eliminating ambient noise. The microphone matrix 121 may include a plurality of microphones 120 arranged in a matrix, and the plurality of microphones 120 may be arranged in other regular shapes such as circles or polygons.

This embodiment is illustrated with a guitar as the source of sound of the instrument, and this embodiment does not specifically limit the musical instruments applied in the recording device 1 provided in the present disclosure. The pickup unit 110 and pickup assembly 130 can be installed directly inside the guitar The microphone 120 can be positioned on the surface of the guitar facing the user. Or the microphone 120 can be mounted on the side of the guitar facing the user. The guitar can be an all-in-one instrument with recording, mixing, and other functions, which greatly facilitates the use of instrument enthusiasts as well as performers. The number of the microphones 120 is 6 or more, and multiple microphones 120 can be arrayed on the side surface of the guitar facing the player to facilitate the pickup of human voices. In this case, the microphone matrix 121 identifies the noise reflected back from the periphery and other directions, transmits the sound signal to the pickup assembly 130, and carries out comparison and noise elimination through the algorithm set in the pickup assembly 130, making the recorded human voice clearer and improving the quality after mixing. The pickup unit 110 is a piezoelectric transducer, and the pickup unit 110 is affixed to the inside of the sound hole of the guitar. The pickup unit 110 is used to pick up the playing sound inside the guitar sound cavity while the guitar is being played.

And the pickup assembly 130 in the third embodiment also includes the filter circuit unit 131, the codec 132 and the audio processing circuit unit 133 as shown in FIG. 2.

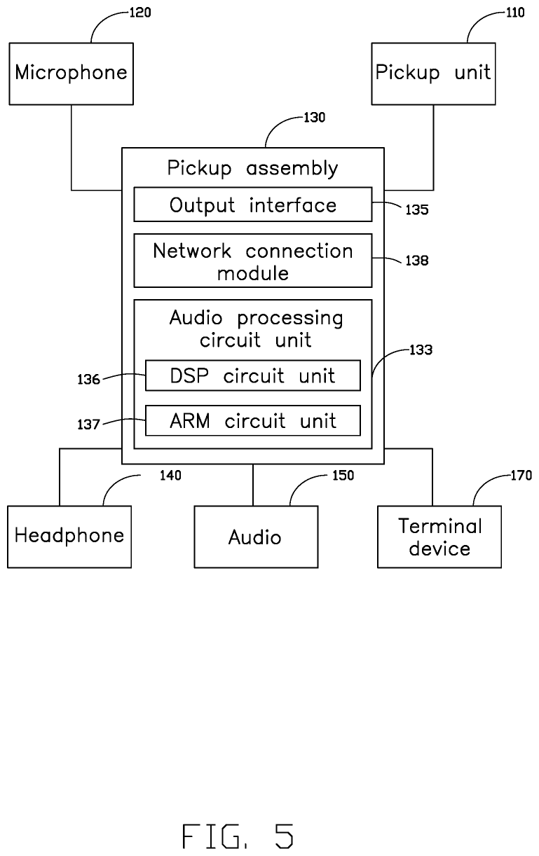

In a fourth embodiment as shown in FIG. 5, the pickup assembly 130 further includes an output interface 135. The output interface 135 is configured to connect to headphones 140 or audio 150. The output interface 135 can also be connected to other types of audio output devices as well as video output devices, making the pickup assembly 130 more richly expandable. The audio processing circuit unit 133 includes a Digital Signal Processing (DSP) circuit unit 136 and an Advanced RISC Machines/microprocessor(ARM) circuit unit 137 for implementing the mixing function of the audio processing circuit unit 133 as well as the recording storage function. The pickup assembly 130 also includes a network connection module 138, and the network connection module 138 is used to realize the network connection function of the pickup assembly 130. And the pickup assembly 130 in the fourth embodiment also includes the filter circuit unit 131, the codec 132 and the audio processing circuit unit 133 as shown in FIG. 2.

The output interface 135 can be an audio interface for connecting external devices such as microphone 120, audio 150, headphones 140, etc. The output interface 135 port can be a 6.35 mm interface or a 3.5 mm interface, and a combination of the 6.35 mm interface and the 3.5 mm. Based on this, the output interface 135 can be adapted to most of the electronic devices, thus improving the utility of the recording device 1.

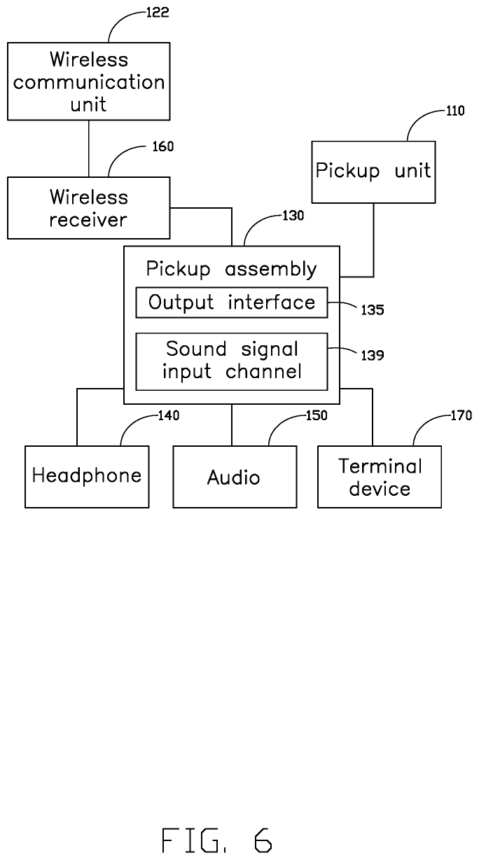

In a fifth embodiment as shown in FIG. 6, the audio processing circuit unit 133 is connected to a wireless receiver 160, which is used to receive wireless communication signals. The microphone 120 may include a wireless communication unit 122. The wireless communication unit 122 transmits sound signals to the pickup assembly 130 through the wireless receiver 160 to enable the pickup assembly 130 to record and mix.

The pickup assembly 130 further includes a sound signal input channel 139, and the sound signal input channel 139 is used to receive external human voices input to the pickup assembly 130. The wireless receiver 160 and the output interface 135 for connecting the headphones 140 are both connected to the sound signal input channel 139 to share the sound signal input channel 139. And the pickup assembly 130 in the fifth embodiment also includes the filter circuit unit 131, the codec 132 and the audio processing circuit unit 133 as shown in FIG. 2.

When the wireless receiver 160 is communicatively connected to the wireless communication unit 122, and the output interface 135 is connected to the headphone 140 with microphone function. The sound signal input channel 139 is occupied by the wireless communication unit 122 in priority, the microphone input function of the headphone 140 is turned off, and the pickup assembly 130 only receives the sound signal input from the wireless communication unit 122 at this time.

When the wireless receiver 160 is not communicatively connected to the wireless communication unit 122, and the output interface 135 is connected to the headphone 140 with microphone function. The sound signal input channel 139 is occupied by microphones on the headphone 140 and the pickup assembly 130 receives the sound signal input by the microphone on the headphone 140.

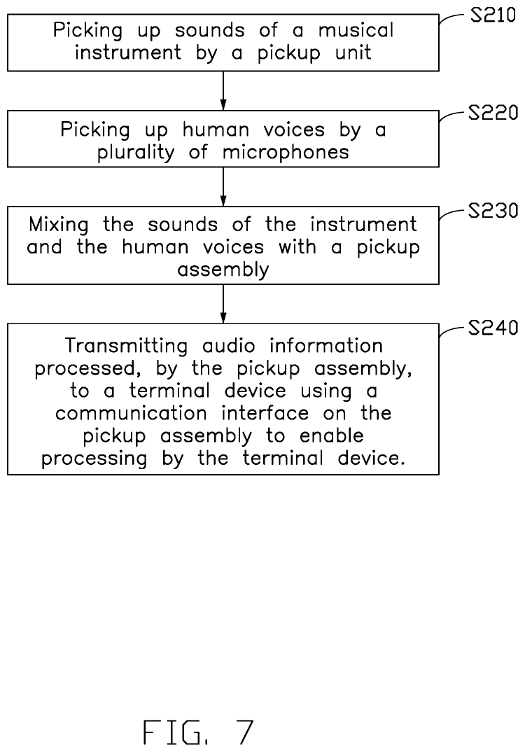

The present application also provides a recording method, applied to the recording device of any of the preceding embodiments. As shown in FIG. 7, the recording method comprising:

Step S210: picking up sounds of a musical instrument by a pickup unit 110.

Step S220: picking up human voices by a plurality of microphones 120.

Step S230: mixing the sounds of the musical instrument that are picked up by the pickup unit 110 and the human voices that are picked up by the plurality of microphones 120 with a pickup assembly 130.

In another embodiment, wherein after mixing the sounds of the musical instrument and the human voices into audio information, the method further comprising:

Step S240: transmitting the audio information processed, by the pickup assembly 130, to a terminal device 170 using a communication interface 134 on the pickup assembly 130 to enable processing by the terminal device 170.

The pickup assembly 130 records and mixes the instrument sound picked up by the pickup unit 110 and the human voice picked up by the microphone 120. The sound information is transmitted to the terminal device 170 using the communication interface 134 on the pickup assembly 130. The instrument sound as well as the human voice can be synchronized when the user uses the terminal device 170 for live broadcasting. Its easy for the user to use the guitar for playing and singing, etc.

The embodiments shown and described above are only examples. Therefore, many commonly-known features and details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A recording device, comprising:
a pickup unit for picking up sounds of musical instrument;
a plurality of microphones for picking up human voices;
a pickup assembly comprising a filter circuit unit, a codec, and an audio processing circuit unit, wherein the pickup unit is connected to the filter circuit unit, the filter circuit unit is connected to the codec, the codec is connected to the audio processing circuit unit, the plurality of microphones is connected to the audio processing circuit unit, the pickup assembly mixes the sounds of musical instruments picked up by the pickup unit and the human voices picked up by the plurality of microphones.

2. The recording device of claim 1, wherein the pickup assembly comprises a communication interface, the communication interface is connected to the audio processing circuit unit, and the communication interface is in communication with a terminal device.

3. The recording device of claim 2, wherein the communication interface is a USB interface or a Bluetooth interface.

4. The recording device of claim 1, wherein the plurality of microphones assists in elimination of ambient noise.

5. The recording device of claim 4, wherein the plurality of microphones are arranged in a matrix to form a microphone matrix.

6. The recording device of claim 5, wherein the microphone matrix comprises six microphones.

7. The recording device of claim 4, wherein the plurality of microphones is positioned on the surface of the musical instrument facing the user, or the plurality of microphone is mounted on the side of the musical instrument facing the user.

8. The recording device of claim 1, wherein the pickup assembly comprises an output interface, the output interface connects to a headphone or an audio.

9. The recording device of claim 8, wherein the output interface is an audio interface.

10. The recording device of claim 8, wherein the output interface is a 6.35 mm interface or a 3.5 mm interface.

11. The recording device of claim 1, wherein the audio processing circuit unit comprises a Digital Signal Processing (DSP) circuit unit and an Advanced RISC Machines/microprocessor (ARM) circuit unit, the DSP circuit unit and the ARM circuit unit implement the mixing and a recording storage.

12. The recording device of claim 1, wherein the pickup assembly comprises a network connection module, the network connection module is connected to the audio processing circuit unit, and the network connection module implements a network connection of the pickup assembly.

13. The recording device of claim 1, wherein the audio processing circuit unit connects to a wireless receiver, the wireless receiver receives wireless communication signals.

14. The recording device of claim 13, wherein the plurality of microphones comprises a wireless communication unit, the wireless communication unit transmits sound signals to the pickup assembly via the wireless receiver to enable the pickup assembly to record and mix.

15. The recording device of claim 14, wherein the pickup assembly comprises a sound signal input channel, the sound signal input channel receives external human voices input to the pickup assembly.

16. The recording device of claim 15, wherein the wireless receiver and the output interface that is configured for connecting headphones are connected to the sound signal input channel, and the wireless receiver and the output interface connect to the sound signal input channel.

17. A recording method comprising:
picking up sounds of a musical instrument by a pickup unit;
picking up human voices by a plurality of microphones; and
mixing the sounds of the musical instrument that are picked up by the pickup unit and the human voices that are picked up by the plurality of microphones with a pickup assembly.

18. The recording method of claim 17, wherein after mixing the sounds of the musical instrument and the human voices into audio information, the method further comprising:
transmitting the audio information processed, by the pickup assembly, to a terminal device using a communication interface on the pickup assembly to enable processing by the terminal device.
